(19) United States
(12) Patent Application Publication
(10) Pub. No.: US 2015/0251568 A1
(43) Pub. Date: Sep. 10, 2015

(54) CHILD'S SEAT ASSEMBLY

(71) Applicant: Jane, S.A., Palau De Plegamans (Barcelona) (ES)

(72) Inventor: Dolores MARTINEZ PEREZ, Barcelona (ES)

(73) Assignee: Jane, S.A.

(21) Appl. No.: 14/619,502

(22) Filed: Feb. 11, 2015

(30) Foreign Application Priority Data
Mar. 4, 2014 (ES) 201430288

(51) Int. Cl. B60N 2/28

(52) U.S. Cl. CPC B60N 2/2872; B60N 2/2812; B60N 2/2821; B60N 2/2851

(57) ABSTRACT

The aim of this invention is to offer a child's seat assembly that generally has sides and headrest and where the child is secured with straps. This child's seat assembly comprises two seats of different dimensions, the smaller one fitting first on top of the larger one, which has straps for securing the child, these straps are used in the smaller seat when it is fitted onto the larger seat, then, when the child has grown, it will be seated on the larger seat after removing the smaller one. This seat assembly can be used in the different stages of growth of a child in a practical manner and without needing the incorporation of mechanisms to do this.

### TECHNICAL FIELD OF THE INVENTION

This child's seat assembly that generally has sides and headrest and where the child is secured with straps.

### BACKGROUND OF THE INVENTION

There are many models of child's seats on the market of said characteristics, among which we can include those that are for small children and those for older children.

There are also child's seats that characteristically have mechanisms that enable the sides to be separated, the headrest to be raised, and some even allow the seat to be widened laterally to adapt to the child's growth.

This latter version of a child's seat, although it has the advantage that it can be used in the different stages of growth of a child, presents the disadvantage of a high price due to the presence of these mechanisms, which also complicates the manufacturing of the seat and they do not always work perfectly, nor are they practical for use by people who are not technically minded to handle the controls of said mechanisms.

### SUMMARY OF THE INVENTION

The aim of this invention is to offer a child's seat assembly that can be used by children of different sizes in a practical manner and without mechanisms, comprising characteristically two seats of different dimensions, the smaller one fitting first on top of the larger one, which has straps for securing the child, these straps are used in the smaller seat when it is fitted onto the larger seat, then, when the child has grown, it will be seated on the larger seat after removing the smaller one.

Another feature of this seat is that is can be manufactured at a low cost and in addition it absorbs pressure or impacts caused, for example, in collisions, for which both seats are entirely made of single moulded elements, made of spongy material with adequate rigidity to absorb energy.

These and other characteristics will be best made apparent by the following detailed description whose understanding will be made easier by the accompanying three sheets of drawings showing a practical embodiment being cited only by way of an example not limiting the scope of the present invention.

### DESCRIPTION OF THE DRAWINGS

In the drawings:

FIG. 1 depicts a perspective view of the seat assembly referred to in this invention when used by a small child sitting on the smaller chair,

FIG. 2 shows a perspective view of the separation of both seats in the assembly, and

FIG. 3 shows a perspective view of the use of the larger for an older child, with the smaller seat removed.

### DETAILED DESCRIPTION OF A PREFERRED EMBODIMENT OF THE INVENTION

As can be seen in the attached drawings, the child's seat assembly comprises two seats of different sizes, one (1) smaller and the other (2) larger.

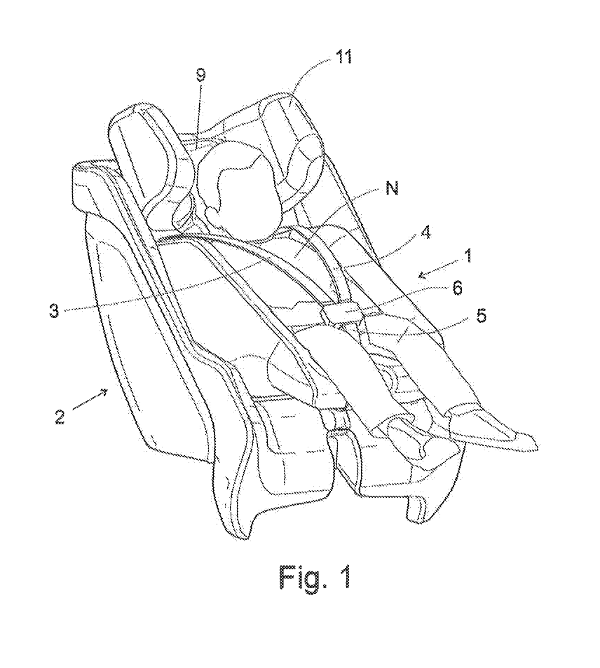

When using this seat initially, namely when the child (N) is very small, the child (N) is seated on the smaller seat (1), which (1) is fitted onto the larger seat (2), as can be seen in FIG. 1.

The larger seat (2) has the conventional straps used on this kind of seat, which in this case has three securing points, two for the straps (3 and 4) and one for the crotch strap (5), the other straps (3 and 4) are attached to the crotch strap (5) with a buckle or catch (6).

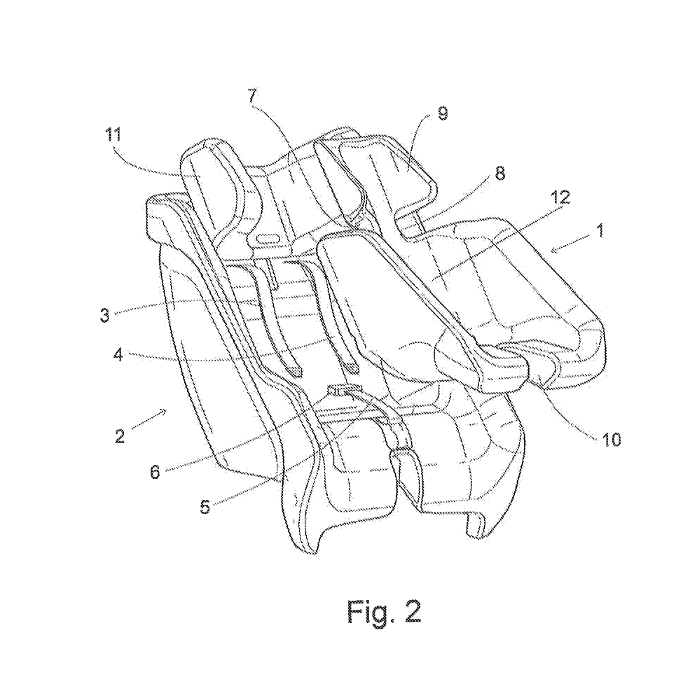

These straps (3, 4 and 5) are also used to secure the child in the smaller seat (1), with the straps (3 and 4) passing through openings (7 and 8) (see FIG. 2) on the sides of the back (12) and the headrest (9) of the smaller seat (1) and the crotch strap (5) passes through an opening (10) on the edge of the seat (1).

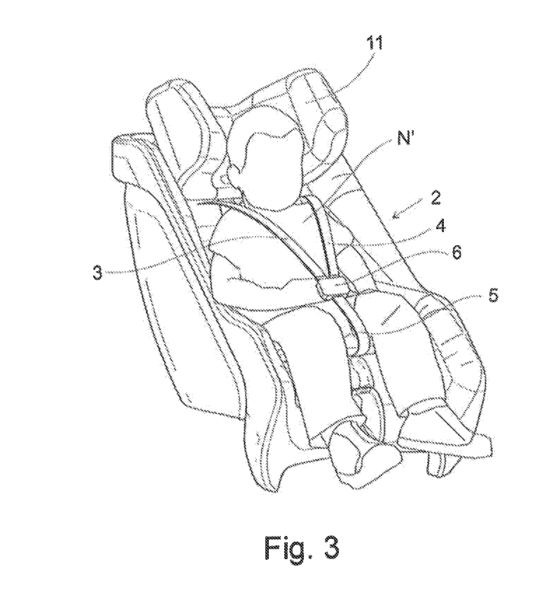

Later, when the child has grown (N′), it (N′) can be seated on the larger (see FIG. 3) seat (2), once the smaller seat (1) has been removed, as can be seen in FIG. 2. In this larger seat (2), the headrest (11) is fitted independently, being adjustable in height to adapt to the size of the child when it grows.

Both seats (1) and (2) are made of single moulded pieces of the desired shape and entirely made of spongy and rigid material (e.g. expanded polypropylene or expanded polystyrene) that absorbs pressure and impact in collisions.

These single moulded components will have a surface finish and can be completed with upholstery.

This seat assembly is preferably designed as a safety seat for children when travelling in automobiles; however, it could also be adapted to be used in children's pushchairs.

The invention can within its essentiality be put into practice in other embodiments differing only in detail from the one having been described above only by way of example, said other embodiments also falling within the scope of the protection being claimed. This child's seat assembly may thus be manufactured in any shape and size, with the most suitable means and materials and with the most convenient accessories, and the components may be replaced by others that are technically equivalent, as all of this is contained within the spirit of the claims.

1. A child's seat assembly comprising sides and headrest, wherein it has two seats of different dimensions, the smaller one fitting first on top of the larger one, which has straps for securing the child, these straps are used in the smaller seat when it is fitted onto the larger seat, then, when the child has grown, it will be seated on the larger seat after removing the smaller one.

2. The child's seat assembly, according to the claim 1, wherein the smaller seat has openings laterally, between the back and the headrest and on the edge for the passage of the straps fitted to the larger seat.

3. The child's seat assembly, according to the claim 1, wherein both seats are made of single moulded pieces of the desired shape and entirely made of spongy and rigid material that absorbs pressure and impact in collisions.

4. The child's seat assembly, according to the claim 3, wherein the single moulded components have a surface finish and/or upholstery.
